(19) United States
(12) Patent Application Publication
(10) Pub. No.: US 2015/0370310 A1
(43) Pub. Date: Dec. 24, 2015

(54) ELECTRONIC DEVICE

(71) Applicant: PANASONIC INTELLECTUAL PROPERTY MANAGEMENT CO., LTD., Osaka (JP)

(72) Inventor: YOSHITAKA HIRABAYASHI, Osaka (JP)

(73) Assignee: PANASONIC INTELLECTUAL PROPERTY MANAGEMENT CO., LTD., Osaka (JP)

(21) Appl. No.: 14/765,534

(22) PCT Filed: Jan. 31, 2014
(86) PCT No.: PCT/JP2014/000508

§ 371 Date: Aug. 3, 2015

(30) Foreign Application Priority Data
Feb. 8, 2013 (JP) 2013-022886

(51) Int. Cl. G06F 1/32

(52) U.S. Cl. CPC G06F 1/3293; G06F 1/3287

(57) ABSTRACT

The electronic device, which is to be carried by the user, has a first inertial force sensor, a second inertial force sensor, an action-mode determiner, and a controller. The action-mode determiner determines an action mode of the user based on at least one of a first inertial force signal fed from the first inertial force sensor and a second inertial force signal fed from the second inertial force sensor. When the action-mode determiner determines that the user starts a first action based on the first inertial force signal or on both of the first inertial force signal and the second inertial force signal, the controller reduces power to be supplied to the first inertial force sensor.

### TECHNICAL FIELD

The present invention relates to mobile electronic devices, such as mobile phones, electronic books, and tablet-type information terminals.

### BACKGROUND ART

FIG. 12A is a perspective view showing mobile electronic device 1 known in the art. Electronic device 1 contains angular velocity sensor 2 and acceleration sensor 3 whose power consumption is smaller than that of angular velocity sensor 2.

FIG. 12B is a flowchart illustrating the workings of electronic device 1. It is evaluated whether or not electronic device 1 is in operation (S01). When it is determined that the device is not in operation, power supply to angular velocity sensor 2 is stopped (S02). While no power is being supplied to angular velocity sensor 2, acceleration sensor 3 detects acceleration (at S03). If the detected value of acceleration is greater than a threshold (in the case of ‘Yes’ at S04), it is determined that the electronic device 1 is in operation and power supply to angular velocity sensor 2 is resumed (S05).

As prior art documents relating to the present invention, for example, Patent literature 1 (PLT 1) is known.

### CITATION LIST

### Patent Literature

### PTL 1:

International Publication 2009/008411

### SUMMARY OF THE INVENTION

The present invention provides an electronic device to be carried by a user. The first electronic device of the present invention has a first inertial force sensor, a second inertial force sensor, an action-mode determiner, and a controller. The first inertial force sensor converts a first inertial force into an electric signal and outputs it as a first inertial force signal. The second inertial force sensor converts a second inertial force different from the first inertial force into an electric signal and outputs it as a second inertial force signal. The action-mode determiner determines an action mode of the user based on at least one of the first inertial force signal and the second inertial force signal. When the action-mode determiner determines, based on the first inertial force signal or on both the first and the second inertial force signals, that the user starts a first action, the controller reduces power to be supplied to the first inertial force sensor. Alternatively, when the action-mode determiner determines, based on the second inertial force signal, that the user stops the first action, the controller increases power to be supplied to the first inertial force sensor.

The second electronic device of the present invention has a first inertial force sensor and a second inertial force sensor that are similar to those of the structure above, and a controller connected to the first and the second inertial force sensors. When detecting recurrent cyclic change in the first inertial force signal or in both the first inertial force signal and the second inertial force signal, the controller reduces power to be supplied to the first inertial force sensor. Alternatively, when detecting non-cyclic change in the second inertial force signal, the controller increases power to be supplied to the first inertial force sensor.

According to the first and the second electronic devices of the present invention, upon detecting the start of the user's action, the devices shift the first inertial force sensor into the power saving mode, thereby reducing power consumption. Further, upon detecting the stop of the user's first action, the devices shift the first inertial force sensor back to the normal mode without impairment of user convenience.

### BRIEF DESCRIPTION OF DRAWINGS

FIG. 1 is a block diagram of an electronic device in accordance with a first exemplary embodiment.

FIG. 2 is a schematic view showing the electronic device shown in FIG. 1.

FIG. 3 is an imaging view showing the electronic device shown in FIG. 1 put on a user's body.

FIG. 4A is a waveform chart of angular velocity signals when the user walks while maintaining the state shown in FIG. 3.

FIG. 4B is a waveform chart of acceleration signals when the user walks while maintaining the state shown in FIG. 3.

FIG. 5A is a waveform chart of angular velocity signals when the user walks slowly while maintaining the state shown in FIG. 3.

FIG. 5B is a waveform chart of acceleration signals when the user walks slowly while maintaining the state shown in FIG. 3.

FIG. 6 is a flowchart of the workings of the electronic device shown in FIG. 1.

FIG. 7 is a block diagram of an electronic device in accordance with a second exemplary embodiment.

FIG. 8 is a flowchart of the workings of the electronic device shown in FIG. 7.

FIG. 9 is a block diagram of an electronic device in accordance with a third exemplary embodiment.

FIG. 10 is a flowchart of the workings of the electronic device shown in FIG. 9.

FIG. 11 is a flowchart of other workings of the electronic device shown in FIG. 9.

FIG. 12A is a perspective view illustrating an electronic device known in the art.

FIG. 12B is a flowchart of the workings of the electronic device shown in FIG. 12A.

### DESCRIPTION OF EMBODIMENTS

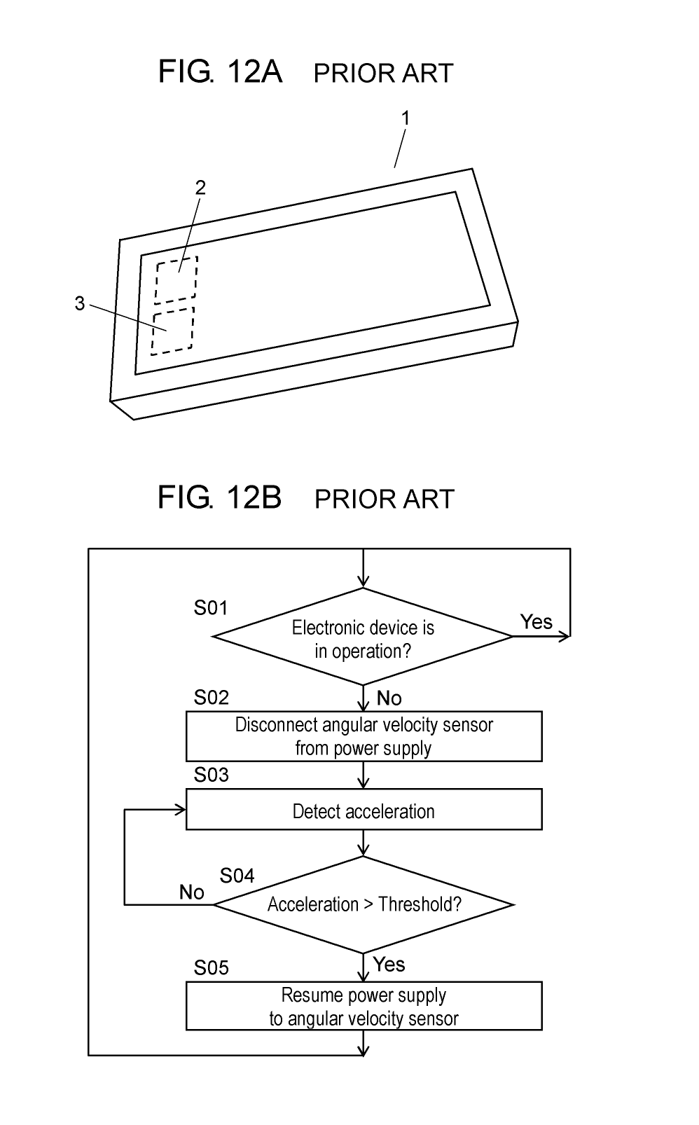

Prior to the description of the embodiments of the present invention, the problem of conventional electronic device 1 shown in FIG. 12A will be described. According to electronic device 1, whether the user is operating the device or not is determined by the output of acceleration sensor 3. When electronic device 1 is determined as being not in operation, power supply to angular velocity sensor 2 is stopped, so that electronic device 1 decreases power consumption.

However, even when the output of angular velocity sensor 2 is not needed while the user is operating electronic device 1, the output of acceleration sensor 3 is detected. Therefore, power supply to angular velocity sensor 2 cannot be stopped. As a result, power consumption of electronic device 1 is large. For example, the aforementioned condition is seen when electronic device 1 detects user's walking. During the user walks at a constant speed, angular velocity sensor 2 outputs signals with the same pattern of waveform repeated. Under the situation, it is no need to continuously supply angular velocity sensor 2 with electric power; nevertheless, the output signal of acceleration sensor 3 is detected together with that of angular velocity sensor 2, and thus, power supply to angular velocity sensor 2 cannot be controlled by using the output signal of acceleration sensor 3.

Hereinafter, an electronic device of the exemplary embodiments will be described with reference to accompanying drawings. The electronic device is capable of reducing power supply to the angular velocity sensor while the user is operating the device

### First Exemplary Embodiment

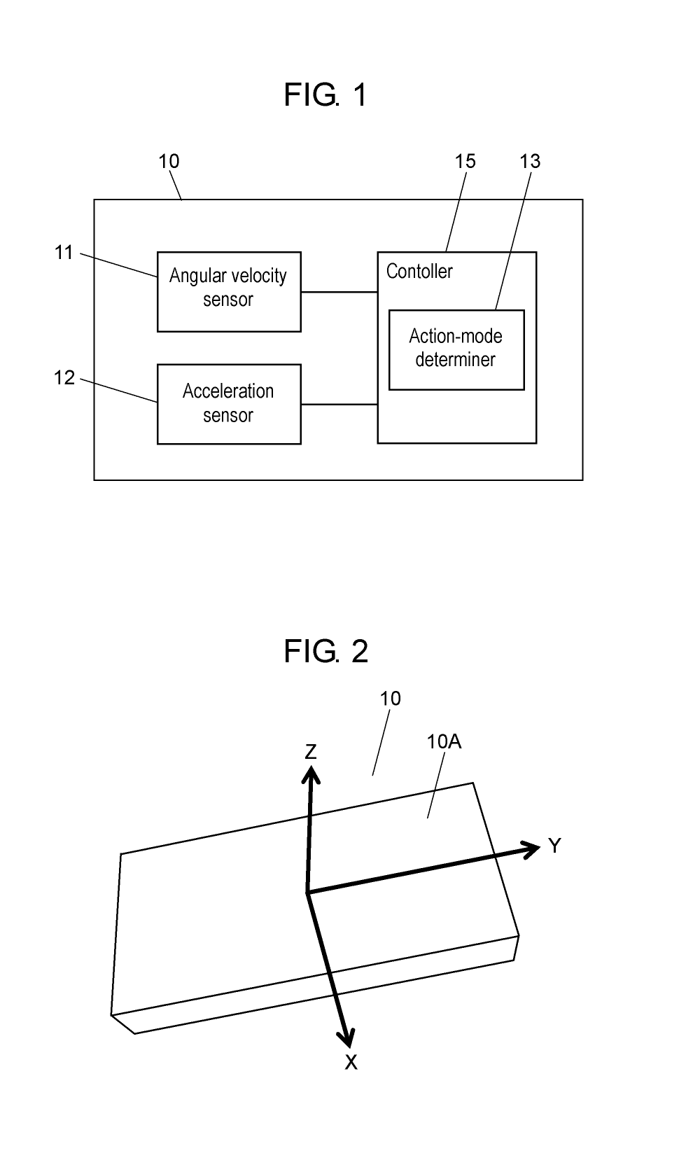

FIG. 1 is a block diagram of electronic device 10 in accordance with the present embodiment. Electronic device 10 is to be carried by a user. Electronic device 10 has angular velocity sensor 11 as a first inertial force sensor, acceleration sensor 12 as a second inertial force sensor, and controller 15 that includes action-mode determiner (hereinafter, referred as determiner) 13. Angular velocity sensor 11 converts angular velocity as a first inertial force into an electric signal and outputs it as an angular velocity signal i.e., as a first inertial force signal. Acceleration sensor 12 converts Coriolis force as a second inertial force that is different from the first inertial force into an electric signal and outputs it as an acceleration signal i.e. as a second inertial force signal. Acceleration sensor 12 and angular velocity sensor 11 are connected to determiner 13. Determiner 13 determines an action mode of the user based on at least one of the angular velocity signal and the acceleration signal. When determiner 13 determines, based on the angular velocity signal or on both of the angular velocity signal and the acceleration signal, that the user starts a first action, controller 15 reduces power to be supplied to angular velocity sensor 11.

FIG. 2 is a schematic view showing electronic device 10. X-axis and Y-axis are perpendicular to each other and they are parallel to upper surface 10A of electronic device 10, and Z-axis is perpendicular to upper surface 10A.

Angular velocity sensor 11 detects respective angular velocities around X-axis, Y-axis, and Z-axis and outputs respective angular velocity signals to determiner 13. Note that a positive angular velocity on each axis is detected in the clockwise direction seen from the user, whereas a negative angular velocity on each axis is detected in the counterclockwise direction seen from the user. Acceleration sensor 12 detects respective accelerations along directions of X-axis, Y-axis, and Z-axis and outputs respective acceleration signals to determiner 13.

Next, the output signals of angular velocity sensor 11 and acceleration sensor 12 when electronic device 10 is used will be described hereinafter as well as determination of determiner 13 based on the output signals. The description below takes an example in which the user walks with electronic device 10 put on his/her body.

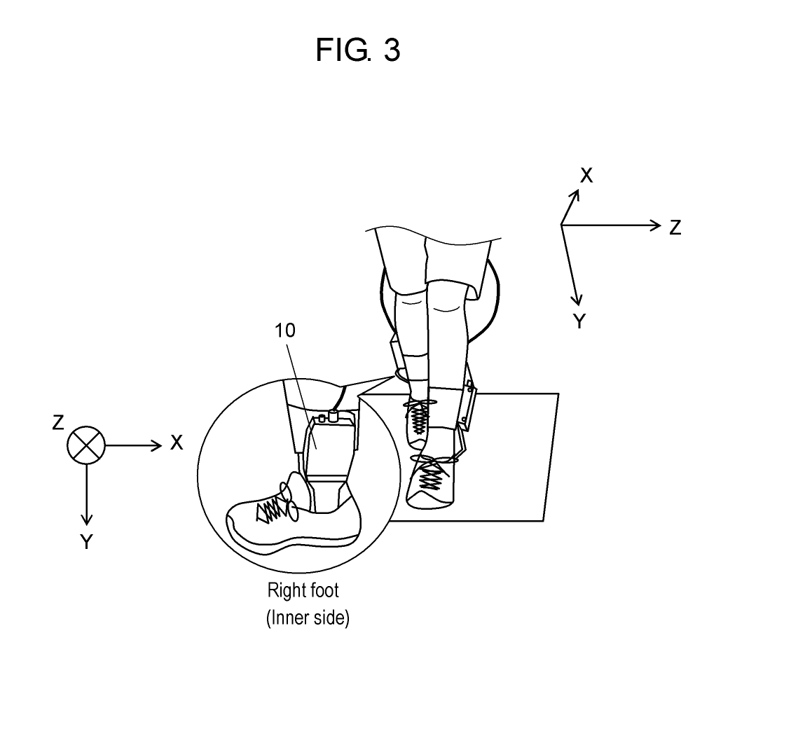

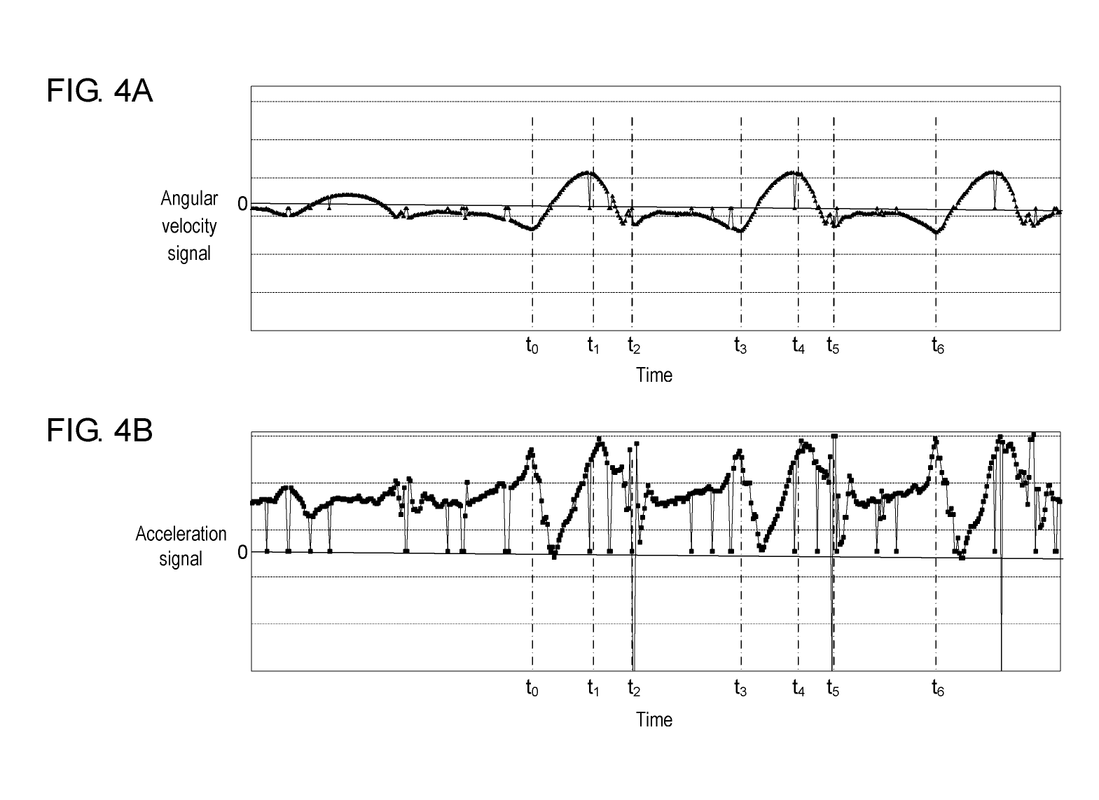

FIG. 3 is a schematic view showing electronic device 10 put on a user's body. FIGS. 4A and 4B are waveform charts showing angular velocity signals and acceleration signals, respectively, when the user walks while maintaining the state shown in FIG. 3. The horizontal axis of each chart represents time and the vertical axis represents the magnitude of the angular velocity signal or the acceleration signal. The description hereinafter takes an example in which electronic device 10 is put on user's right foot, as shown in FIG. 3.

When the user raises the foot in the device-mounted state for walking, rotation around Z-axis of electronic device 10 is generated, producing a positive value of the angular velocity signal around Z-axis as shown in FIG. 4A (between time t₀ and time t₁). In the period of time, as shown in FIG. 4B, the value of the acceleration signal in the Y-axis direction decreases and then increases. Thus, the waveform of the acceleration signal shows a downward peak (i.e., minus peak).

When the user lowers the foot, negative rotation around Z-axis is generated, decreasing the value of the angular velocity signal around Z-axis (as shown between time t₁ and time t₂). When the foot touches down to the ground (corresponding t₀ time t₂), a large negative value of the angular velocity signal in the Y-axis direction is generated. In the walk motion, the angular velocity signal and the acceleration signal repeatedly show a characteristic pattern (hereinafter, characteristic waveform), as described above. That is, detecting the characteristic waveform allows the device to determine the start of walking of the user.

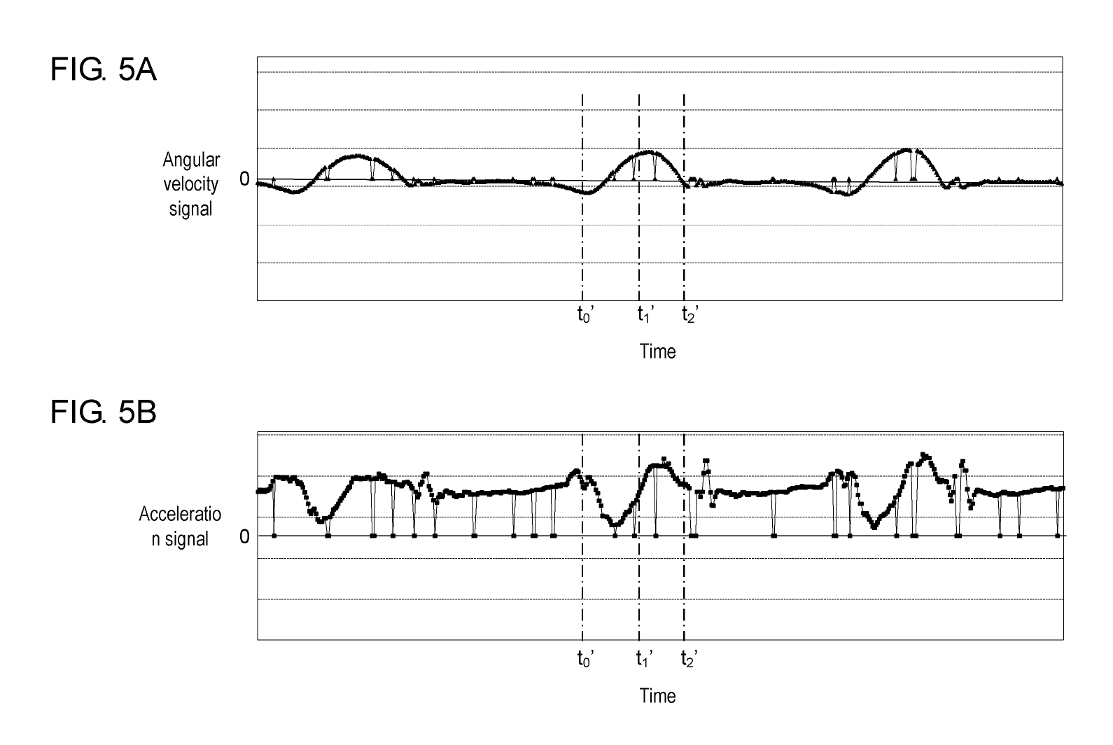

In particular, when the user walks slowly at a lowered speed, the angular velocity signal is effectively used for determining an action mode of the user. FIGS. 5A and 5B are waveform charts of the angular velocity signal and the acceleration signal, respectively, when the user walks slowly while maintaining the state shown in FIG. 3.

In the walking motion described earlier, a large negative value of the angular velocity signal is characteristically produced in the Y-axis direction as shown at time t₂ in FIG. 4B. In contrast, when the user walks slowly, no such a negative value is produced (as shown at time t₂′). On the other hand, the value of the angular velocity signal around Z-axis (between time t₁′ and time t₂′) shows the characteristics as similar to those shown in FIG. 4A between time t₁ and t₂. Considering above, angular velocity sensor 11 detects user's walking with accuracy higher than acceleration sensor 12.

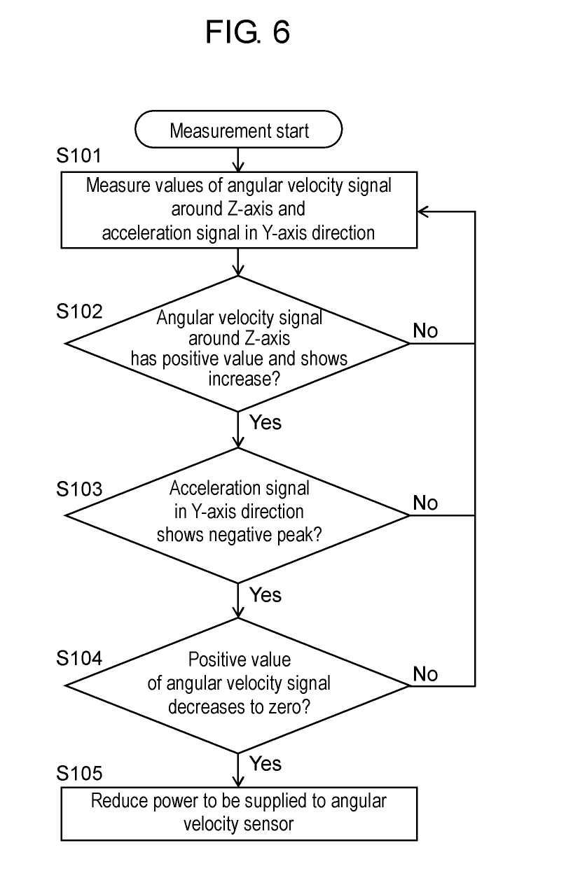

Next, a specific example of determination by determiner 13 will be described with reference to FIG. 6. FIG. 6 is a flowchart showing the workings of electronic device 10.

In S101, angular velocity sensor 11 measures a value of the angular velocity signal around Z-axis, and acceleration sensor 12 measures a value of the acceleration signal in the direction of Y-axis. Alternatively, angular velocity sensor 11 may measure the values of respective angular velocity signals around the three axes, and acceleration sensor 12 may measure the values of respective acceleration signals in the directions of the three axes. Out of the measured values, determiner 13 obtains the angular velocity signal around Z-axis and the acceleration signal in the direction of Y-axis.

In S102, determiner 13 determines whether or not the angular velocity signal around Z-axis has a positive value and whether or not the positive value increases. If the angular velocity signal has a positive value and it increases, the procedure goes to S103; otherwise, it goes back to S101.

In S103, determiner 13 determines whether or not the negative peak occurs in the acceleration signal in the direction of Y-axis while the value of the angular velocity signal around Z-axis is positive. If the negative peak is detected, the procedure goes to S104; otherwise, it goes back to S101.

In S104, determiner 13 determines whether or not the positive value of the angular velocity signal around Z-axis decreases to 0. If the positive value of the angular velocity signal around Z-axis decreases to 0, determiner 13 determines that the user starts walking and the procedure goes to S105; otherwise, it goes back to S101.

In S105, controller 15 reduces power to be supplied to angular velocity sensor 11.

As described above, when the angular velocity signal and the acceleration signal show characteristic waveforms, determiner 13 determines that the user starts walking. In response to the determination, controller 15 reduces power to be supplied to angular velocity sensor 11. After reducing power to be supplied to angular velocity sensor 11, if the waveform characteristics seen, for example, in the dispersion, in the area, and in the peak value of the acceleration signal measured between S101 and S105 are repeatedly detected in the subsequent acceleration signal, determiner 13 determines that the user continues the action. As long as determiner 13 determines that the action continues, controller 15 can keep the reduction of power supply to angular velocity sensor 11. Thanks to the structure above, the user's walking action can be determined accurately with use of two inertial force sensors. At the same time, power consumption can be reduced.

Although the description above explains the case where the walking action is detected by characteristic waveforms found in the respective waveforms of the angular velocity signal and the acceleration signal, the present embodiment is not limited to. As for the action in which a pattern is cyclically repeated such as walking, once the start of an action is detected, the similar action is likely to follow. Therefore, the key is how determine the start of an action.

As long as angular velocity sensor 11 is not applied with rotation caused by the start of an action such as walking, it continuously outputs zero or a low level signal caused by noise. For example, if a predetermined threshold is defined to angular velocity sensor 11, the start of user's walking can be detected when angular velocity sensor 11 shows a value exceeding the threshold. When the angular velocity signal has the waveform shown in FIG. 4A, the threshold can be set to a value smaller than the peak value of the angular velocity signal at time t₁. When the angular velocity signal exceeds the threshold, determiner 13 determines the start of user's walking, and in response to the determination, controller 15 can reduce power to be supplied to angular velocity sensor 11. After the reduction of power supply to angular velocity sensor 11, if the waveform characteristics seen, for example, in the dispersion, in the area, and in the peak value of the acceleration signal are repeatedly detected in the subsequent acceleration signal, determiner 13 determines that the user continues the action (walking). As long as determiner 13 determines that the action continues, controller 15 can keep the reduction of power supply to angular velocity sensor 11.

As for an action such as walking in which a pattern is cyclically repeated, if the cyclic pattern is found, it can be assumed that the action starts and the similar action is continued subsequently. That is, if similarity of the waveform of the angular velocity signal between the first cycle and the second cycle is found, it can be assumed that the action continues.

More specifically, in FIG. 4A, the gradient between t₀ and t₁ and the gradient between t₁ and t₂ in the first cycle from t₀ to t₃ are calculated; the gradient between t₃ and t₄ and the gradient between t₄ and t₅ in the second cycle from t₃ to t₆ are calculated; then the t₀-t₁ gradient is compared with the t₃-t₄ gradient, and the t₁-t₂ gradient is compared with the t₄-t₅ gradient. Based on the agreement degree of compared gradients, the waveforms are determined to be coincident. In this case, either one of the gradient comparison may be used for the determination. Although the description shows the determination based on the gradient with respect to the peak of the waveform, the dispersion or the area of the waveform may be employed for the determination.

Alternatively, if a period in which the angular velocity signal generates a waveform and a period in which the acceleration signal generates a waveform are agree with each other, determiner 13 determines that the user starts a predetermined action. For example, as shown in FIG. 4A, the angular velocity signal increases in magnitude from to and then decreases from t₁ toward t₂, thus it can be assumed that a period of the angular velocity signal is completed at t₂. In the same period of time, as shown in FIG. 4B, the acceleration signal has a negative peak in which the value decreases and then increases between t₀ and t₁, and then has an extremely negative value at t₂. That is, it can be assumed that a period of the waveform of the acceleration signal is also completed at t₂. As described above, it can be determined that the periods of the waveforms of the angular velocity signal and the acceleration signal are agree with each other between time t₀ and time t₂. The determination result allows determiner 13 to detect the start of user's walking, and in response to the determination, controller 15 reduces power to be supplied to angular velocity sensor 11.

As for an action such as walking in which a pattern is cyclically repeated, when the cyclic pattern of the waveform of the angular velocity signal successively appears two or more times, it can be determined that the walking is started. For example, in the graph of FIG. 4A, the period between t₀ and t₃ is a first period and the period between t₃ and t₆ is a second period that follows the first period. If the waveform cycles of the sequential periods agree with each other, determiner 13 determines that the user starts a predetermined action. After the determination of the start of walking, power to be supplied to angular velocity sensor 11 can be reduced. The first period and the second period may be consecutive or may have an interval therebetween.

Although the description above describes the structure in which determiner 13 is contained in controller 15, determiner 13 may be disposed separately from controller 15 and may transmit the determination result to controller 15. As another possible structure, determiner 13 may be disposed in the detecting circuit of angular velocity sensor 11 and acceleration sensor 12, and determiner 13 may be disposed in a microprocessor different from that contains the inertial force sensor part of electronic device 10. Besides, determiner 13 and controller 15 may be formed of a dedicated circuit (as hardware) or may be formed of a universal circuit together with software.

In a structure where controller 15 contains determiner 13, controller 15 is connected to angular velocity sensor 11 and acceleration sensor 12. When the angular velocity signal repeats a cyclic change or both of the angular velocity signal and the acceleration signal repeat cyclic changes, controller 15 reduces power to be supplied to angular velocity sensor 11. It may be assumed that electronic device 10 is thus structured.

In the structure above, controller 15 reduces power to be supplied to angular velocity sensor 11 when the waveform of the angular velocity signal in the first cycle agrees with the waveform of the acceleration signal in the second cycle, for example. Alternatively, controller 15 reduces power to be supplied to angular velocity sensor 11 when a period in which the angular velocity signal generates a waveform and a period in which the acceleration signal generates a waveform are agree with each other. Further alternatively, controller 15 reduces power to be supplied to angular velocity sensor 11 when the waveform cycle of the angular velocity signal in the first period agrees with that of the angular velocity signal in the second period successive to the first period.

### Second Exemplary Embodiment

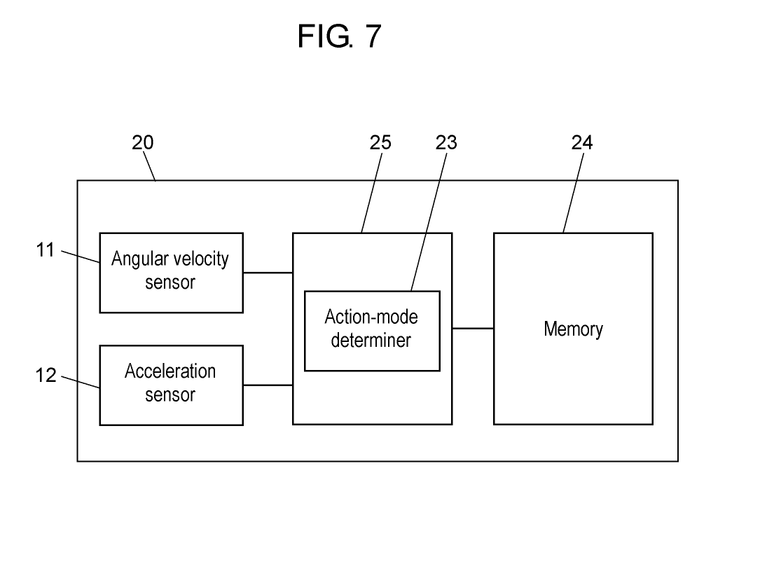

FIG. 7 is a block diagram of electronic device 20 in accordance with the second exemplary embodiment of the present invention. Electronic device 20 has memory 24, which is different from electronic device 10 described in the first embodiment.

Memory 24 is connected to action-mode determiner (hereinafter, referred as determiner) 23. That is, memory 24 is connected to controller 25. Memory 24 stores a characteristic waveform (a first waveform) of angular velocity sensor 11 obtained by the user's predetermined action, for example, the walking action. In advance, a predetermined waveform or a characteristic waveform specific to the user may be stored as a first waveform in memory 24. For example, a first waveform specific to the user may be stored as follows. The user walks for a constant distance (or a constant period of time) while monitoring the waveform of the angular velocity signal; and a characteristic waveform is extracted from the repeatedly measured waveforms and is stored into memory 24.

Determiner 23 is connected to angular velocity sensor 11, acceleration sensor 12, and memory 24. Receiving a waveform of the angular velocity signal from angular velocity sensor 11, determiner 23 compares it with the first waveform stored in memory 24. In the comparison, for example, determiner 23 employs a threshold based on difference or a correlation factor both between the values measured at predetermined times, and determines whether or not the two waveforms agree with (or are similar to) each other. As for determination with use of difference between the values measured at predetermined times, square error is generally employed so that the positive and the negative errors do not cancel out with each other. The square error is calculated by squaring the differences by time and adding them by time of waveform. As for determination with the correlation factor, the correlation factor is obtained by dividing the covariance of the waveform of the angular velocity signal and the characteristic waveform stored in memory 24 by each standard deviation.

If the waveform of the angular velocity sensor 11 agrees with the first waveform as a result of the determination, determiner 23 determines that the measured waveform of the angular velocity signal is produced by walking action and the user starts walking. In response to the determination of determiner 23, controller 25 reduces power to be supplied to angular velocity sensor 11.

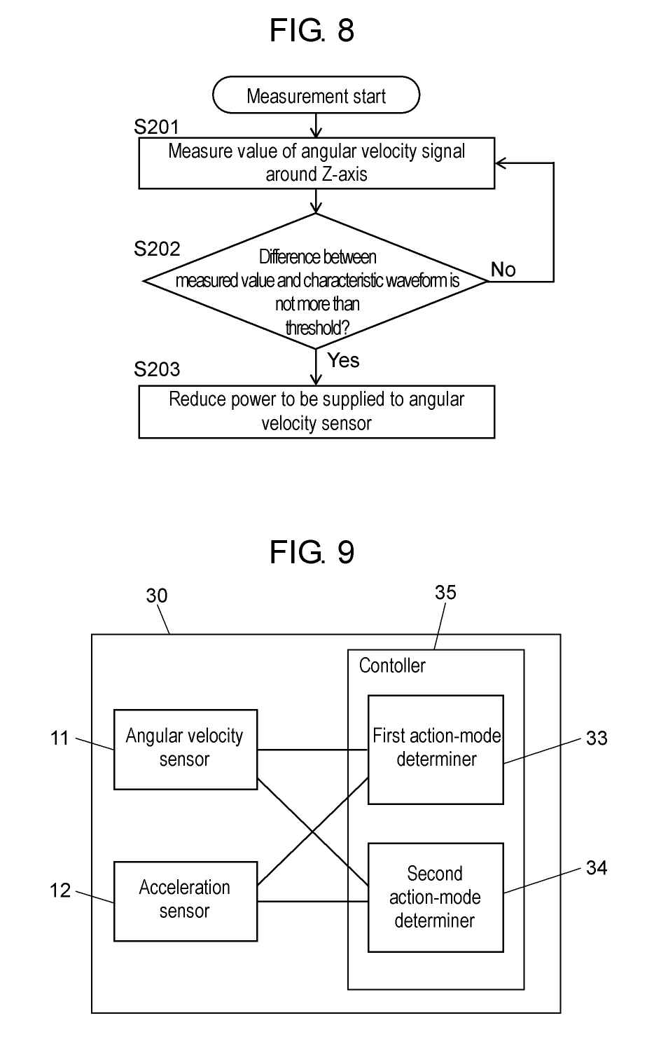

Next, a specific example of determination of determiner 23 will be described with reference to FIG. 8. FIG. 8 is a flowchart illustrating the workings of electronic device 20. The description below will be given on the premises that electronic device 20 is put on the user in a similar manner shown in FIG. 3 and the waveforms of the angular velocity signal and the acceleration signal detected from the action mode of the user are the same as those shown in FIGS. 4A and 4B.

In S201, angular velocity sensor 11 measures a value of the angular velocity signal around Z-axis. Alternatively, angular velocity sensor 11 measures the values of respective angular velocity signals around the three axes and determiner 23 obtains the angular velocity signal on Z-axis among them.

In S202, determiner 23 compares the threshold with the difference between the waveform of the measured value and the first waveform stored in memory 24. If the difference is not more than the threshold, determiner 23 determines that the user starts walking, and the procedure goes to S203; otherwise, goes back to S201. In S203, controller 25 reduces power to be supplied to angular velocity sensor 11.

As described above, when determiner 23 determines that the user starts walking on the result of comparison between the first waveform and the waveform of the angular velocity sensor, controller 25 reduces power to be supplied to angular velocity sensor 11. After reducing power to be supplied to angular velocity sensor 11, if the waveform characteristics seen, for example, in the dispersion, in the area, and in the peak value of the acceleration signal measured between S201 and S203 are repeatedly detected in the subsequent acceleration signal, determiner 23 determines that the user continues the action. As long as determiner 23 determines that the action continues, controller 25 keeps the reduction of power supply to angular velocity sensor 11.

Although the description above shows an example in which the difference between values measured by time is employed for comparison between the waveform of the angular velocity signal and the first waveform stored in memory 24, it is not limited to; threshold setting based on, for example, a correlation function may be employed.

Besides, in the description above, power to be supplied to angular velocity sensor 11 is reduced according to the angular velocity signal, but it is not limited to. For example, employing combination of results detected by angular velocity sensor 11 and by acceleration sensor 12 allows determiner 23 to determine the walking action with higher accuracy. In that case, memory 24 stores a second waveform in addition to the first waveform. If the waveform of the angular velocity signal agrees with the first waveform and the waveform of the acceleration signal agrees with the second waveform, determiner 23 determines that the user starts a first action (walking).

Like the structure described in the first embodiment, determiner 23 may be disposed separately from controller 25. In a structure in which controller 25 contains determiner 23, controller 25 is connected to angular velocity sensor 11, acceleration sensor 12, and memory 24. When the angular velocity signal repeats a cyclic change or both of the angular velocity signal and the acceleration signal repeat cyclic changes, controller 25 reduces power to be supplied to angular velocity sensor 11. It may be assumed that electronic device 20 is thus structured. To be specific, if the waveform of the angular velocity signal agrees with the first waveform stored in memory 24, or if the waveform of the angular velocity signal agrees with the first waveform stored in memory 24 and the waveform of the acceleration signal agrees with the second waveform stored in memory 24, controller 25 reduces power to be supplied to angular velocity sensor 11.

Although the reduction of power supply in the descriptions in the first and the second embodiment is referred to angular velocity sensor 11, it is not limited to; for example, power to be supplied to acceleration sensor 12 can be reduced. However, angular velocity sensor 11 consumes power greater than acceleration sensor 12 due to its structural feature, because angular velocity sensor 11 employs an oscillator that oscillates with application of voltage from outside. Considering above, reducing power to be supplied to angular velocity sensor 11 is more effective because angular velocity sensor 11 consumes power greater than acceleration sensor 12.

### Third Exemplary Embodiment

FIG. 9 is a block diagram of electronic device 30 in accordance with the third exemplary embodiment. Electronic device 30 is different from electronic device 10 of the first embodiment in that controller 35 contains first action-mode determiner (hereinafter referred as first determiner) 33 and second action-mode determiner (hereinafter referred as second determiner) 34 both configured to determine the action mode of the user. Angular velocity sensor 11 and acceleration sensor 12 are connected to first determiner 33 and second determiner 34.

First determiner 33 is the same as determiner 13 shown in FIG. 1. That is, first determiner 33 determines an action mode of the user based on at least one of the angular velocity signal and the acceleration signal. When first determiner 33 determines, based on the angular velocity signal or on both of the angular velocity signal and the acceleration signal, that the user starts a first action, controller 35 reduces power to be supplied to angular velocity sensor 11. The determination method of first determiner 33 is similar to that described in the first embodiment and the detailed description thereof will be omitted.

On the other hand, second determiner 34 determines the action mode of the user based on the acceleration signal. When second determiner 34 determines that the user stops the first action, controller 35 increases power to be supplied to angular velocity sensor 11.

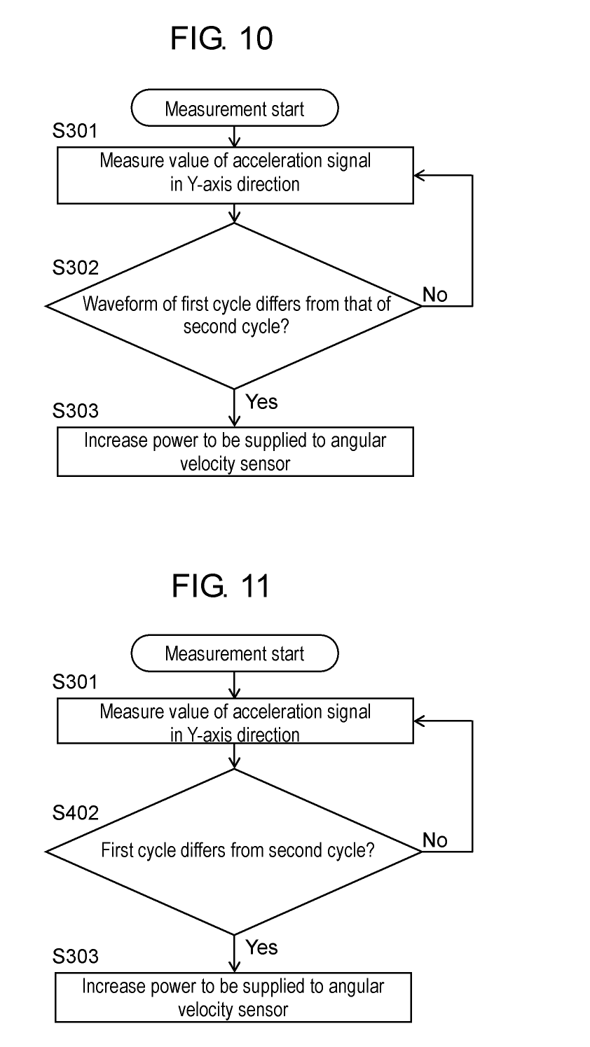

Next, determination of user's action by second determiner 34 and control by controller 35 based on the determination result will be described with reference to FIGS. 10 and 11. FIGS. 10 and 11 are flowcharts illustrating an example of the workings of electronic device 30.

In S301 in FIG. 10, acceleration sensor 12 measures a value of the acceleration signal in the direction of Y-axis or measures values of the angular velocity around three axes. Second determiner 34 obtains the acceleration signal in the direction of Y-axis among them.

In S302, it is determined whether or not the waveform of the acceleration signal in the direction of Y-axis in the first period is different form that in the second period. In the determination, as described earlier, the square error or the correlation factor is calculated and the calculated value is compared with the predetermined threshold. If the calculated value is equal to or greater than the threshold, second determiner 34 determines that the user stops the first action such as walking, and the procedure goes to S303; otherwise, it goes back to S301.

In S303, controller 35 increases power to be supplied to angular velocity sensor 11.

As described above, when the waveform of the acceleration signal in the first cycle is different from that in the second cycle, second determiner 34 determines that the user stops a predetermined action.

In the description above, a method for determining the stop of user's action based on the comparison between the waveforms of the respective acceleration signals of the first cycle and of the second period, but it is not limited to. For example, a memory may be provided like in the second embodiment. In that case, the second determiner may determine that the user stops walking based on the comparison between the waveform of the acceleration signal and the second waveform stored in the memory. The first cycle and the second cycle may be consecutive or may have an interval therebetween.

Next, another example of the workings of electronic device 30 will be described with reference to FIG. 11. The workings of the device in S301 and S303 are the same as those in FIG. 10 and the description thereof will be omitted.

In S402, it is determined whether or not the first cycle and the second cycle of the acceleration signal in the direction of Y-axis are different from each other. In this determination, the difference between the two cycles is calculated and the calculated difference is compared with a predetermined threshold. If the calculated value is equal to or greater than the threshold, second determiner 34 determines that the user stops walking. That is, if the cycles of the respective acceleration signals in the first period and in the second period are different from each other, second determiner 34 determines that the user stops the first action and the procedure goes to S303; otherwise, it goes back to S301.

As described above, when the first cycle and the second cycle of the acceleration signal are different from each other, second determiner 34 determines that the user stops a predetermined action. Meanwhile, the method in which the first cycle and the second cycle of the acceleration signal are compared is described above; however, it is not limited to. For example, the structure may contain a memory where a predetermined cycle is stored in advance, and the stored cycle may be compared with the first cycle. The first cycle and the second cycle may be consecutive or may have an interval therebetween.

In the description above, for convenience sake, first determiner 33 and second determiner 34 are individually provided, but they may be formed of an identical processor. In other words, determiner 13 of the first embodiment may function as both of first determiner 33 and second determiner 34. In that case, if determiner 13 determines that the user starts the first action based on the angular velocity signal or on both of the angular velocity signal and the acceleration signal, controller 15 reduces power to be supplied to angular velocity sensor 11. In contrast, if determiner 13 determines that the user stops the first action based on the acceleration signal, controller 15 increases power to be supplied to angular velocity sensor 11.

Like in the structure of the first embodiment, at least one of first determiner 33 and second determiner 34 may be disposed separately from controller 35. In a structure where controller 35 contains first determiner 33 and second determiner 34, controller 35 is connected to angular velocity sensor 11 and acceleration sensor 12. In response to non-cyclic change occurred in the acceleration signal, controller 35 increases power to be supplied to angular velocity sensor 11. It may be assumed that electronic device 30 is thus structured. Specifically, when the waveforms of the acceleration signals in the first cycle and in the second cycle are different from each other, controller 35 increases power to be supplied to angular velocity sensor 11. Alternatively, when the cycle of the acceleration signal in the first period is different from that in the second period, controller 35 increases power to be supplied to angular velocity sensor 11.

Although the increase of power supply in the description above is referred to angular velocity sensor 11, it is not limited to; for example, power supply to acceleration sensor 12 can be increased. However, it is more effective to reduce power to be supplied to a component which consumes more electricity among angular velocity sensor 11 and acceleration sensor 12 (i.e., angular velocity sensor 11 in the embodiment) and to increase the power as needed.

Although the structure described above has first determiner 33 and second determiner 34, only second determiner 34 may be disposed as the action-mode determiner, and power-supply reduction to angular velocity sensor 11 may be manually performed.

In the descriptions of the first through the third embodiments, the electronic device employs angular velocity sensor 11 and acceleration sensor 12, but it is not limited to; for example, instead of acceleration sensor 12, the device may employ a pressure sensor as the second inertial force sensor. A pressure sensor detects vertical movement of approximately 10 cm, thus, the sensor can be used instead of acceleration sensor 12.

Meanwhile, in the descriptions above, the determination by the determiner is based on the angular velocity signal of angular velocity sensor 11 around Z-axis, or on both of the angular velocity signal of angular velocity sensor 11 around Z-axis and the acceleration signal of acceleration sensor 12 in the direction of Y-axis. This is because the electronic device is put on the user as shown in FIG. 3 in the example. That is, it is appropriately changed to us an angular velocity signal on which axis or to us an acceleration signal in which axial direction according to how the electronic device is used. Alternatively, out of the angular velocity signals around the three axes, the signal with the greatest change may be selected; similarly, out of the acceleration signals in the direction of the three axes, the signal with the greatest change may be selected for the determination.

Besides, the wording “agree with” in the description does not necessarily mean in the strict sense when it is used in comparison between, for example, the waveforms and the cycles; they agree with each other when they have a correlation therebetween.

Further, the descriptions of the first through the third embodiments take the walking action as an action mode of the user, but it is not limited to walking. The structure of the embodiments is widely applicable to an action in which a cyclic pattern repeatedly appears, such as rowing boat/canoe, riding bicycle, skating, and swimming.

Electronic devices 10, 20, and 30 may contain a display so that the user can easily recognize the measurement result.

### INDUSTRIAL APPLICABILITY

According to the electronic device of the present invention, the angular velocity sensor of the device can be shifted into the power-saving mode while the user is operating the device. The structure having the advantage above is suitable for electronic devices, such as mobile phones, electronic books, and tablet-type information terminals.

### REFERENCE MARKS IN THE DRAWINGS

10, 20, 30 electronic device
10A upper surface
11 angular velocity sensor (first inertial force sensor)
12 acceleration sensor (second inertial force sensor)
13, 23 action-mode determiner (determiner)
24 memory
33 first action-mode determiner (first determiner)
34 second action-mode determiner (second determiner)

1. An electronic device to be carried by a user, comprising:
a first inertial force sensor configured to convert a first inertial force into an electric signal which is output as a first inertial force signal;
a second inertial force sensor configured to convert a second inertial force different from the first inertial force into an electric signal which is output as a second inertial force signal;
an action-mode determiner configured to determine an action mode of the user based on at least one of the first inertial force signal and the second inertial force signal; and
a controller configured to reduce power to be supplied to the first inertial force sensor when the action-mode determiner determines, based on the first inertial force signal or on both of the first inertial force signal and the second inertial force signal, that the user starts a first action.

2. The electronic device according to claim 1, wherein the action-mode determiner is configured to determine that the user starts the first action when output of the first inertial signal exceeds a first threshold.

3. The electronic device according to claim 1, wherein the action-mode determiner is configured to determine that the user starts the first action when the first inertial force signal in a first cycle agrees, in waveform, with the first inertial force signal in a second cycle.

4. The electronic device according to claim 1, wherein the action-mode determiner is configured to determine that the user starts the first action when a period where the first inertial force signal generates a waveform agrees with a period where the second inertial force signal generates a waveform.

5. The electronic device according to claim 1, wherein the action-mode determiner is configured to determine that the user starts the first action when a waveform cycle of the first inertial force signal in a first period agrees with that of the first inertial force signal in a second period.

6. The electronic device according to claim 1 further comprising:
a memory connected to the action-mode determiner and storing a first waveform,
wherein the action-mode determiner is configured to determine that the user starts the first action when a waveform of the first inertial force signal agrees with the first waveform.

7. The electronic device according to claim 1 further comprising:
a memory connected to the action-mode determiner and storing a first waveform and a second waveform,
wherein the action-mode determiner is configured to determine that the user starts the first action when the first inertial force signal has a waveform that agrees with the first waveform and the second inertial force signal has a waveform that agrees with the second waveform.

8. The electronic device according to claim 1 further comprising:
a second action-mode determiner configured to determine an action mode of the user based on the second inertial force signal,
wherein the controller increases the power to be supplied to the first inertial force sensor when the second action-mode determiner determines that the user stops the first action.

9. The electronic device according to claim 1, wherein the controller increases the power to be supplied to the first inertial force sensor when the action-mode determiner determines, based on the second inertial force signal, that the user stops the first action.

10. The electronic device according to claim 1, wherein the first action is a walk.

11. An electronic device to be carried by a user comprising:
a first inertial force sensor configured to convert a first inertial force into an electric signal which is output as a first inertial force signal;
a second inertial force sensor configured to convert a second inertial force different from the first inertial force into an electric signal which is output as a second inertial force signal;
an action-mode determiner configured to determine an action mode of the user based on at least any one of the first inertial force signal and the second inertial force signal; and
a controller configured to increase power to be supplied to the first inertial force sensor when the action-mode determiner determines, based on the second inertial force signal, that the user stops a first action.

12. The electronic device according to claim 11, wherein the action-mode determiner is configured to determine that the user stops the first action when a waveform of the second inertial force signal in a first cycle is different from that of the second inertial force signal in a second cycle.

13. The electronic device according to claim 11, wherein the action-mode determiner is configured to determine that the user stops the first action when a waveform cycle of the second inertial force signal in a first period is different from that of the second inertial force signal in a second period.

14. An electronic device comprising:
a first inertial force sensor configured to convert a first inertial force into an electric signal which is output as a first inertial force signal;
a second inertial force sensor configured to convert a second inertial force different from the first inertial force into an electric signal which is output as a second inertial force signal; and
a controller connected to the first inertial force sensor and the second inertial force sensor and configured to reduce power supplied to the first inertial force sensor when the first inertial force signal changes periodically or both the first inertial force signal and the second inertial force signal change periodically.

15. The electronic device according to claim 14, wherein the controller is configured to reduce the power supplied to the first inertial force sensor when a waveform of the first inertial force signal in a first cycle agrees with that of the first inertial force signal in a second cycle.

16. The electronic device according to claim 14, wherein the controller is configured to reduce the power to be supplied to the first inertial force sensor when a period where a period where the first inertial force signal generates a waveform agrees with a period where the second inertial force signal generated a waveform.

17. The electronic device according to claim 14, wherein the controller is configured to reduce the power supplied to the first inertial force sensor when a waveform cycle of the first inertial force signal in a first period agrees with that of the first inertial force signal in a second period.

18. The electronic device according to claim 14 further comprising:
a memory connected to the controller and storing a first waveform,
wherein the controller is configured to reduces the power to be supplied to the first inertial force sensor when a waveform of the first inertial force signal agrees with the first waveform.

19. The electronic device according to claim 14 further comprising:
a memory connected to the controller and storing a first waveform and a second waveform,
wherein the controller is configured to reduce the power to be supplied to the first inertial force sensor when a waveform of the first inertial force signal agrees with the first waveform and a waveform of the second inertial force signal agrees with the second waveform.

20. The electronic device according to claim 14, wherein the controller is configured to increase the power to be supplied to the first inertial force sensor when the second inertial force signal changes in non-cyclic manner.

21. An electronic device comprising:
a first inertial force sensor configured to convert a first inertial force into an electric signal which is output as a first inertial force signal;
a second inertial force sensor configured to convert a second inertial force different from the first inertial force into an electric signal which is output as a second inertial force signal; and
a controller connected to the first inertial force sensor and the second inertial force sensor and configured to increase power to be supplied to the first inertial force sensor when the second inertial force signal changes in non-cyclic manner.

22. The electronic device according to claim 21, wherein the controller is configured to increase the power to be supplied to the first inertial force sensor when a waveform of the second inertial force signal in a first cycle is different from that of the second inertial force signal in a second cycle.

23. The electronic device according to claim 21, wherein the controller is configured to increase the power to be supplied to the first inertial force sensor when the second inertial force signal in a first period has a different cycle from that of the second inertial force signal in a second period.
